(19) United States
(12) Patent Application Publication
(10) Pub. No.: US 2017/0289089 A1
(43) Pub. Date: Oct. 5, 2017

(54) HELMET WITH INFORMATION-SHARING FUNCTION

(71) Applicant: JARVISH INC., Taipei City (TW)

(72) Inventor: Younger Liang, Taipei City (TW)

(21) Appl. No.: 15/086,069

(22) Filed: Mar. 31, 2016

(51) Int. Cl. H04L 12/58; H04W 4/02; H04L 29/06; H04N 5/225; G06T 11/60

(52) U.S. Cl. CPC H04L 51/32; H04N 5/2252; G06T 11/60; H04L 67/42; H04W 4/02

(57) ABSTRACT

A helmet with information-sharing function includes a helmet transmitting unit directly or indirectly connected to a server, by which edited information integrated with at least one captured image and at least one sensed signal of the helmet is uploaded and posted to a social media.

### FIELD OF THE INVENTION

The present invention relates to a helmet, and more specifically, to a helmet that is connected to a server and can post edited information integrated with at least one captured image and at least one sensed signal on a social media after they are transmitted and uploaded to the server.

### BACKGROUND OF THE INVENTION

To protect a rider's head, a helmet is widely used in various riding activities and several related devices are installed thereon, such as an event data recorder, which is normally installed on a motorcycle to record information related to crashes or accidents as proof of accidents while riding.

However, the event data recorder can only record the information surrounded the rider while riding except the rider's status, such as riding posture, height, or geographic coordinates, and is incapable of directly sharing the recorded information on the internet. It is therefore tried by the inventor to develop an improved helmet with information-sharing function to overcome the above problems.

### SUMMARY OF THE INVENTION

An object of the present invention is to provide a helmet with information-sharing function that can post edited information on at least one social media via a server after edited information being transmitted to a server to integrate with at least one captured image and at least one sensed signal of the helmet.

Another object of the present invention is to provide a helmet with information-sharing function that can generate an image and a sensed signal, both of which contain time and geo-tag, according to which, an editing unit of a server fetches out the corresponding image and sensed data from a database to integrate into edited information and then store in the database.

A further object of the present invention is to provide a helmet with information-sharing function that can generate an image and a sensed signal, which contain time and geo-tag, according to which, an interface template can be applied by a publishing unit of a server to integrate with the edited information within a predetermined time section or a predetermined geo-position to post on a social media.

To achieve the above and other objects, the helmet with information-sharing function connected to a server provided according to the present invention includes a sound collection unit for collecting sounds to generate an instruction signal; a shooting unit for generating at least one image signal; a sensing unit for sensing at least one status of the helmet to generate at least one sensed signal containing a location information; a helmet transmitting unit directly or indirectly connected to the server, and a control unit being connected to the sound collection unit, the shooting unit, the sensing unit, and the helmet transmitting unit and used for receiving the sensed signal and the instruction. The control unit can activate the shooting unit to record and generate an image signal according to the instruction, and transmit the image and sensed signal to the server to store in a database via the helmet transmitting unit. Then, the image and the sensed signal are integrated into edited information to post on at least one social media via the server.

In an embodiment, the control unit has a time module, which generates a time series data, according to which, a time tag is tagged in both the image and sensed signal.

In an embodiment, the sensing unit has a locator for generating a location information, according to which, a geo-tag is tagged in both the image and sensed signal.

In an embodiment, the sensing unit further includes a gyroscope, an accelerometer, an electronic compass, a barometer, an UV index and an ambient light sensor.

In an embodiment, the server includes a server transmitting unit for receiving at least one captured image and sensed signal; a database being connected to the server transmitting unit and used for the captured image and sensed signal to be stored therein; an editing unit being connected to the database and according to the time tag, geo-tag, or the sensed signal, fetching out the corresponding image and sensed data within the same time section or in the same location from the database to integrate into edited information and then store in the database; a publishing unit being connected to the database and having at least one interface template and according to the time tag or geo-tag of edited information, the interface template being applied by the publishing unit of the server to integrate with corresponding edited information within a predetermined time section or a predetermined geo-position to post on a social media.

In an embodiment, the database includes a register module for the image and the sensed signal to be stored therein and a store module for the edited information to be stored therein.

In an embodiment, the helmet transmitting unit is connected to the server via a communication device.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1A is a block diagram of a helmet with information-sharing function according to a preferred embodiment of the present invention;

FIG. 1B is a block diagram of the helmet according to another preferred embodiment of the present invention;

FIG. 2A is a block diagram of a sensing unit included in the helmet according to the preferred embodiment of the present invention;

FIG. 2B is a block diagram of a control unit included in the helmet according to the preferred embodiment of the present invention;

FIG. 2C is a block diagram of a database included in the helmet according to the preferred embodiment of the present invention;

FIG. 3 is a block diagram of a sensing unit included in the helmet according to the preferred embodiment of the present invention; and

FIG. 4 is an explanatory view showing a processing operation of an image data included in the helmet according to the preferred embodiment of the present invention.

### DETAILED DESCRIPTION OF THE PREFERRED EMBODIMENTS

The present invention will now be described with some preferred embodiments thereof and by referring to the accompanying drawings. For the purpose of easy to understand, elements that are the same in the preferred embodiments are denoted by the same reference numerals.

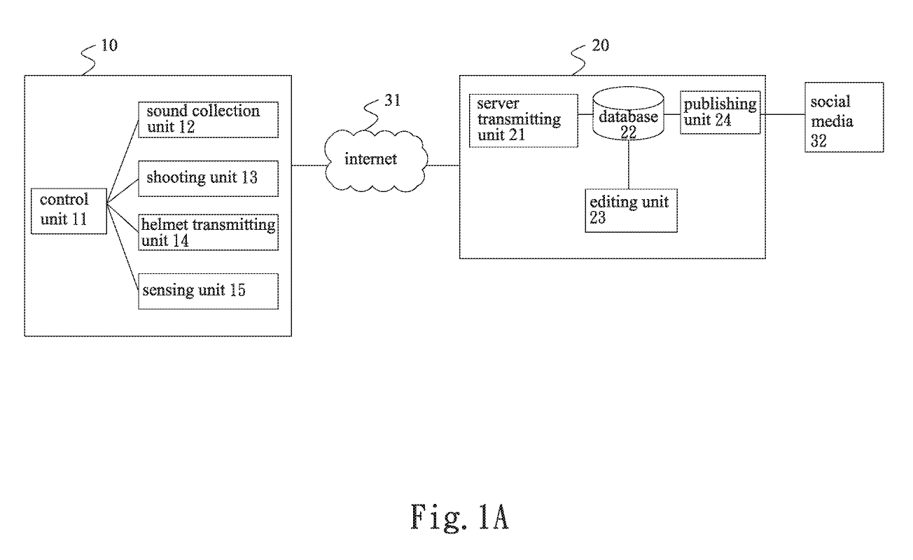

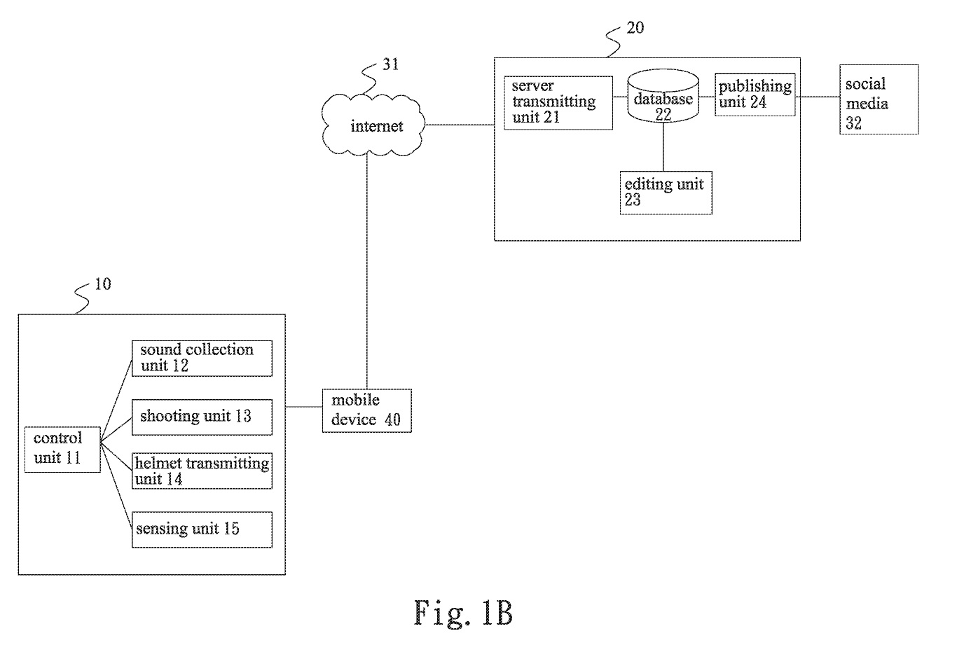

Please refer to FIGS. 1A and 1B, which are two block diagrams of a helmet with information-sharing function according to one and another preferred embodiment of the present invention. As shown, a helmet 10 can be, for example but not limited to, connected to an internet 31 via a mobile device 40, such as a smart phone or tablet PC before connecting to a server 20 via the internet 31. The helmet 10 includes a control unit 11, which is connected to a sound collection unit 12, a shooting unit 13, a helmet transmitting unit 14, and a sensing unit 15.

The sound collection unit 12, such as a microphone, is used for collecting sounds from the user of the helmet 10 and generates an instruction signal. The shooting unit 13, such as a video camera, generates an image signal, such as videos or photos, and can have a microphone built therein, such that shooting unit 13 can generates a sound image signal.

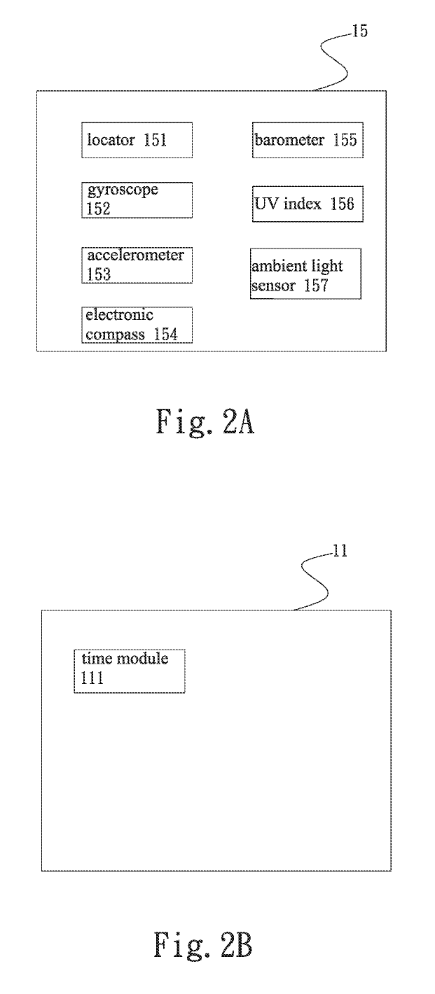

The sensing unit 15 for sensing at least one status of the helmet 10 and generates at least one sensed signal. The helmet status refers to the using status of the user of the helmet 10, including, for example but not limited to, posture, direction, speed, height, location of the user while riding. Please refer to FIG. 2A, which is a block diagram of a sensing unit included in the helmet according to the preferred embodiment of the present invention. The sensing unit 15 includes a locator 151, includes a gyroscope 152, an accelerometer 153, an electronic compass 154, a barometer 155, an UV index 156 and an ambient light sensor 157. The locator 151 is used for generating a location information, i.e. the geographic coordinates, to locate the helmet 10. According to the change of the slant angle of the helmet, the gyroscope 152 generates an acceleration signal including the information in 3 axes. The accelerometer 153 generates a speed and displacement signal according to the speed and displacement of the helmet 10. In the illustrated embodiment, a 3-axis accelerometer is capable of sensing in three-dimension. According to the moving direction of the helmet 10, the electronic compass 154 generates a magnetic flux signal. When the helmet 10 is rotatable relative to the user's head, the gyroscope 152, the accelerometer 153, the electronic compass 154 generate the acceleration, the speed and displacement, and the magnetic flux signal corresponding to determine the movement of the helmet 10. Also, the gyroscope 152, the accelerometer 153, the electronic compass 154 can facilitate the locator 151 to determine the directions the user faces and moving. The barometer 155 senses the air pressure around the user to determine the altitude, air pressure, temperature, and height of helmet 10. The UV index (ultraviolet index) 156 indicates the strength of the UV radiation. The ambient light sensor 157 continuously measures the ambient light in the environment outside the helmet 10.

The helmet transmitting unit 14 can be, for example but not limited to, 3G, 4G, 5G, 6G, WIFI, or Bluetooth module, connected to a wireless network via a wireless network before connecting to the server 20. The wireless signal can be, for example but not limited to, a Bluetooth, HyperLAN, Triple Play, GSM/GPRS, 3G, 3.5G, 4G, IEEE802.11, IEEE802.3, 802.15, 802.11, or Wi-Fi Direct signal. With the wireless signal generated by the helmet transmitting unit 14, the helmet 10 can directly be connected to the server 20 via the internet 31. Alternatively, the helmet 10 can be connected to the mobile device 40 with the wireless signal generated by the helmet transmitting unit 14 before connecting to the server 20.

The control unit 11 can be a CPU or a MPU, and is used for receiving the sensed signal, the instruction. The control unit 11 can activate the shooting unit 13 to record and generate an image signal according to the instruction, and transmit the image and sensed signal to the server 20 to store in a database 22 via the helmet transmitting unit 14. Please refer to FIG. 2B, which is a block diagram of the control unit 11 included in the helmet 10 according to the preferred embodiment of the present invention. As shown, the control unit 11 has a time module 111, which generates a time series data for a period of time (e.g., second, minute, hour, day, etc.), according to which, a time tag is tagged in both the image and sensed signal. Also, according to the location information generated from the locator 151 of the sensing unit 15, a geo-tag, such as latitude and longitude, is tagged in both the image and sensed signal.

Referring to FIGS. 1A and 1B again, after receiving and storing by the server 20, edited information is integrated with the image and sensing signal transmitted from the helmet 10. Thereafter, the edited information is posted on at least one social media, such as Facebook, or Twitter, and the like.

The server 20 includes a server transmitting unit 21, a database 22, an editing unit 23, and a publishing unit 24. The server transmitting unit 21 is connected to the internet 31 for receiving the captured image and sensed signal from the helmet 10. The database 22 is connected to the server transmitting unit 21 and includes a register module for the image and the sensed signal to be stored therein and a store module for the edited information to be stored therein as shown FIG. 2C.

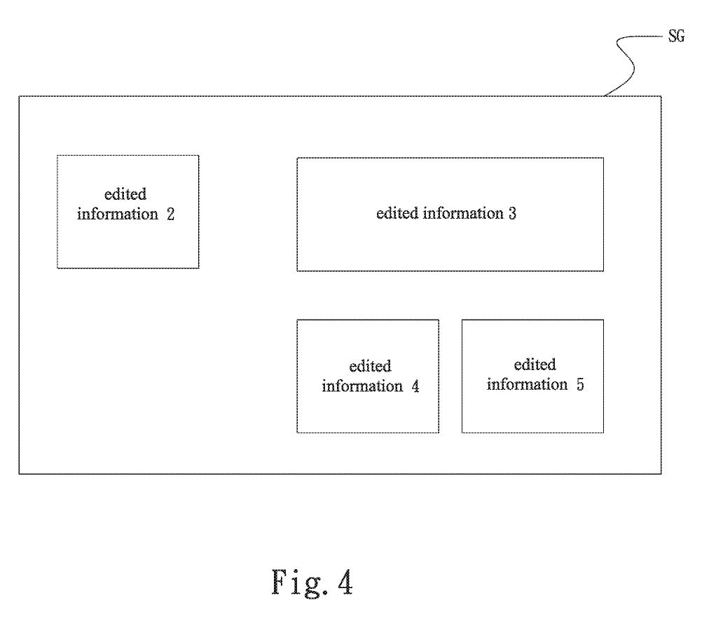

The editing unit 23 is connected to the database 22 and according to the time tag, geo-tag of the image signal or the sensed signal, or the sensed signal, fetches out the corresponding image and sensed data in the same time section or in the same location from the database 22 to integrate into edited information and then store in the store module 222 of the database 22. The publishing unit 24 is connected to the database 22 and has at least one interface template SG and according to the time tag or time tag of edited information of the store module 222 of the database 22, the interface template SG can be applied by the publishing unit 24 of the server 20 to integrate with corresponding edited information within a predetermined time section or a predetermined geo-position to post on the social media 32 as shown in FIG. 4.

It is noted that the image signal of the shooting unit 13 is embedded in various sensed signals, such as head posture, instant speed, height, direction, physical active level like acceleration, and the like to auto-authored into a meaningful information. For example, when the accumulated displacement values sensed by the gyroscope 152 of the sensing unit 15, accelerometer 153, and the electronic compass 23 exceed a predetermined value and maintain for a predetermined period of time, it means the user is looking at something interesting on the roadside. Another example, when accelerometer 153 of the sensing unit 15 stays a fixed value for certain time without sensing meaningful move, it means the user maintains a fixed posture riding and nothing attractive.

When the image signal contains information like the first example, it means previous and next the time point meaningful, whereas like the second example, it means nothing meaningful.

Therefore, the sound collection unit 12 collects the user's breath frequency and/or the locator 151 of the sensing unit 15 generates the location information to facilitately find the uniqueness of the location the user being there then. Furthermore, meaningful images can be found from the first example or the images after deducting the second example.

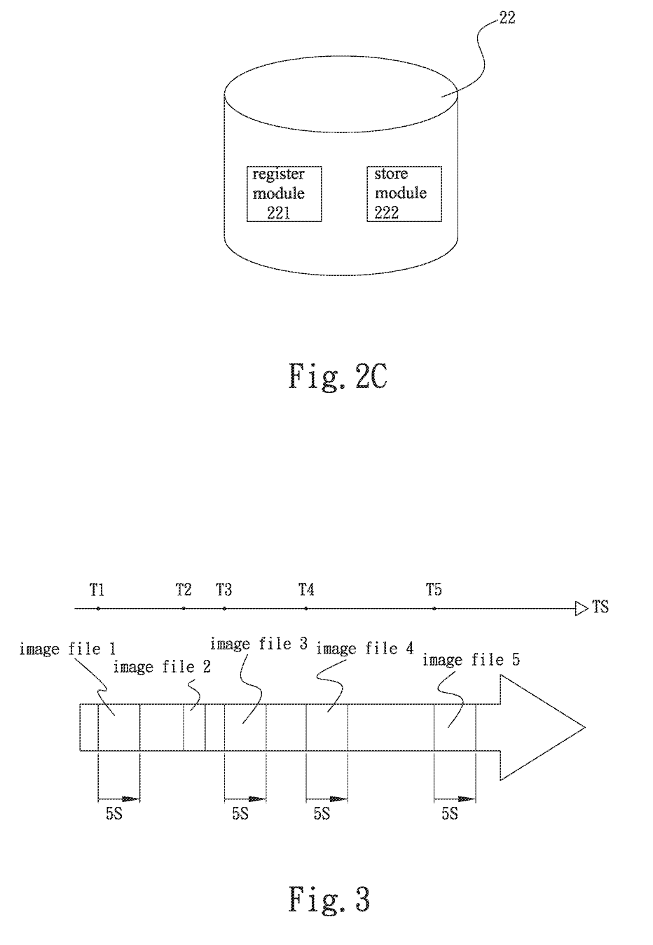

Please refer to FIG. 3, which is a block diagram of a sensing unit included in the helmet according to the preferred embodiment of the present invention, along with FIGS. 1A, 1B, 2A to 2C. As shown, the time module 111 of the control unit 11 generates the time series data TS, and the time point T1 to T5 respectively represent different time points in the time series data TS. The control unit 11 activates the shooting unit 13 to record and generate an image file 1 after receiving an instruction signal generated from the sound collection unit 12 at time point T1. The control unit 11 activates the shooting unit 13 to record and generate an image file 2 after receiving an instruction signal generated from the sound collection unit 12 at time point T2. The rest can be done in the same manner. The image file 1, 3, 4, and 5 are short films, whereas the image file 2 is a photo. In practical implementation, based on the user′ need, the length of each image file can be changed. In the illustrated embodiment, the length of the image file 1, 3, 4, and 5 can be, for example but not limited to, 5 seconds. Also, the time tag of the time point T1 to T5 respectively is tagged in the image file 1 to 5. The sensing unit 15 respectively senses the location of the helmet 10 and helmet status including location information of the user and generates sensed signal at the time point T1 to T5, and then the sensed signal is transmitted to the control unit 11. Thereafter, the time point T1 to T5 are respectively tagged in the sensed signal and transmitted to the server 20 via the internet 31 after the control unit is connected to the internet 31 via the helmet transmitting unit 14. Alternatively, the control unit 11 transmits the sensed signal to the server via the internet 31 after connecting to internet 20 via the helmet transmitting unit 14 and the mobile device 40.

The server transmitting unit 21 of the server 20 receives the sensed signal including the image file 1 to 5, which is transmitted to the register module 221 of the database 22 to store. The editing unit 23 integrates with the image file 1 including the time point T1 of the sensed signal into edited information 1 according to the image file 1 to 5 of the sensed signal stored in the register module 221 of the database 22. The image file 2 including the time point T2 of the sensed signal into edited information 2, and the rest can be done in the same manner. Thereafter, the edited information 1 to 5 is stored in the store module 222 of the database 22.

Please refer to FIG. 4, which is an explanatory view showing a processing operation of an image data included in the helmet according to the preferred embodiment of the present invention, along with FIGS. 1A, 1B, 2A to 2C. According to the time tag or geo-tag of edited information 1 to 5, the publishing unit 24 of the server 20 integrates with corresponding edited information within a predetermined time section or a predetermined geo-position into the interface template SG to post on the social media 32. In the illustrated embodiment, the predetermined section is referred to the time point T2 to T5, the publishing unit 24 integrates with the edited information 2 corresponding to the time point T2, the edited information 3 corresponding to the time point T3, the edited information 4 corresponding to the time point T4, and the edited information 5 corresponding to the time point T5 into the interface template SG to post on the social media 32.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A helmet with information-sharing function connected to a server, comprising:
a sound collection unit for collecting sounds to generate an instruction signal;
a shooting unit for generating at least one image signal;
a sensing unit for sensing at least one status of the helmet to generate at least one sensed signal containing a location information;
a helmet transmitting unit directly or indirectly connected to the server; and
a control unit being connected to the sound collection unit, the shooting unit, the sensing unit, and the helmet transmitting unit and used for receiving the sensed signal and the instruction signal; the control unit being able to activate the shooting unit to record and generate an image signal according to the instruction signal, and the image and sensed signal being transmitted to and stored in the server via the helmet transmitting unit;
wherein the image and the sensed signal are integrated into edited information to post on at least one social media via the server.

2. The helmet as claimed in claim 1, wherein the control unit has a time module, which generates a time series data, according to which, a time tag being tagged in both the image and sensed signal.

3. The helmet as claimed in claim 2, wherein the sensing unit has a locator for generating the location information, according to which, a geo-tag being tagged in both the image and sensed signal.

4. The helmet as claimed in claim 3, wherein the sensing unit further includes a gyroscope, an accelerometer, an electronic compass, a barometer, an UV index and an ambient light sensor.

5. The helmet as claimed in claim 3, wherein the server comprises:
a server transmitting unit for receiving the captured image and sensed signal;
a database being connected to the server transmitting unit and used for the captured image and sensed signal to be stored therein;
an editing unit being connected to the database and according to the time tag, geo-tag, or the sensed signal, fetching out the corresponding image and sensed data within the same time section or in the same location from the database to integrate into edited information and then store in the database;
a publishing unit being connected to the database and having at least one interface template and according to the time tag or geo-tag of edited information, the interface template being applied by the publishing unit of the server to integrate with corresponding edited information within a predetermined time section or a predetermined geo-position to post on a social media.

6. The helmet as claimed in claim 5, wherein the database includes a register module for the image and the sensed signal to be stored therein and a store module for the edited information to be stored therein.

7. The helmet as claimed in claim 1, wherein the helmet transmitting unit is connected to the server via a communication device.
